(19) United States
(12) Patent Application Publication
(10) Pub. No.: US 2003/0129342 A1
(43) Pub. Date: Jul. 10, 2003

(54) Light-sensitive material light-shielding package

(75) Inventors: Yoshio Hara, Kanagawa (JP); Makoto Kawamura, Kanagawa (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/328,012

(22) Filed: Dec. 26, 2002

(30) Foreign Application Priority Data
Dec. 27, 2001 (JP) 2001-396860

(51) Int. Cl. B32B 1/08

(52) U.S. Cl. 428/36.91

(57) ABSTRACT

A roll-form light-sensitive material light-shielding package includes a hollow light-shielding spool 1, a long length of roll-form light-sensitive material 2 wound around the outer periphery of the spool 1, a light-shielding flange 3 having an insertion part 5 that is fitted into a hollow part of the spool 1, the flange abutting against a roll surface of the light-sensitive material 2, and a light-shielding leader 6 joined to the leading edge of the long length of light-sensitive material 2 and covering the outer periphery of the light-sensitive material 2. The package further comprises a cushion layer 8 on the surface of the spool 1, and the cushion layer 8 has a thickness that can absorb expansion of the surface of the spool 1 caused by insertion of the insertion part 5 of the flange 3 into the spool 1.

### BACKGROUND OF THE INVENTION

1. Field of the Invention

The present invention relates to a roll-form light-sensitive material light-shielding package and, more particularly, a roll-form light-sensitive material light-shielding package that can prevent elongation of both sides of the light-sensitive material even when the roll-form light-sensitive material light-shielding package is stored at high temperature for a long period of time.

2. Description of the Related Art

A light-shielding package which enables a light-sensitive material and, in particular, a roll-form light-sensitive material, to be loaded in exposure equipment in an illuminated room is known. For example, JU-B-6-31465 (JU-B denotes a Japanese examined utility model application publication) discloses a roll-form light-sensitive material light-shielding package for use in a platemaking scanner, the package enabling a light-sensitive material to be loaded in an illuminated room. A method for recording on the light-sensitive material of the above package involves loading the light-sensitive material package in a film magazine, drawing out the leading edge portion of a light-shielding leader through a film outlet of the film magazine, and then setting the film magazine in the platemaking scanner in a state in which the light-shielding leader is removed and the leading edge of the light-sensitive material projects out of the film outlet. Recording is then carried out by wrapping the unexposed light-sensitive material around a recording drum and subjecting the light-sensitive material to scanner exposure.

When processing the recorded light-sensitive material, a phenomenon is observed in which the image recorded at the edges of the light-sensitive material is not sharp, the so-called blurring. An investigation into the cause has made it clear that both edges of the light-sensitive material wrapped around the recording drum are elongated, and cannot be adequately attached to the recording drum. As a result, the light-sensitive material becomes detached from the recording drum, and the focus of the scanner cannot be adjusted correctly, thereby giving a blurred image.

With regard to the roll-form light-sensitive material used in platemaking equipment, the light-shielding flange is defined by ISO 14535 (First edition 2001-07-15) so as to be compatible with various types of platemaking equipment. The light-shielding flange can be of a rigid type or a flexible type, and in the case of the rigid type a paper spool is generally used. This is because the rigid type light-shielding flange can be easily fitted by pushing its cylindrical insertion part into the paper spool.

The above-mentioned publication describes the provision of a projection on a cylindrical insertion part of the light-shielding flange so as to prevent it falling out during transport. In accordance with this method, falling out during transport can be prevented without increasing the mating force. However, providing a projection on the cylindrical insertion of the light-shielding flange causes the problem that when the spool and the light-shielding flange are disposed of after the light-sensitive material is consumed, it becomes difficult to pull the light-shielding flange out of the spool.

### BRIEF SUMMARY OF THE INVENTION

It is an object of the present invention to provide a roll-form light-sensitive material light-shielding package that can prevent nonuniform elongation of the side edges of the light-sensitive material and the occurrence of blurring even when the roll-form light-sensitive material light-shielding package is stored for a long period of time.

The above-mentioned object has been attained by the following means.

That is, it is achieved by a roll-form light-sensitive material light-shielding package comprising a hollow light-shielding spool, a long length of roll-form light-sensitive material wound around the outer periphery of the spool, a light-sheilding flange having an insertion part that is fitted into a hollow part of the spool, the flange abutting against a roll surface of the light-sensitive material, a light-shielding leader joined to the leading edge of the long length of light-sensitive material and covering the outer periphery of the light-sensitive material, and a cushion layer on the surface of the spool, wherein the cushion layer has a thickness that can absorb expansion of the spool caused by insertion of the insertion part of the flange into the spool.

### BRIEF DESCRIPTION OF THE DRAWING

FIG. 1A is a partial cross section of one embodiment of the roll-form light-sensitive material light-shielding package of the present invention.

FIG. 1B is an external view of the package in FIG. 1A.

FIG. 2A is a front view showing another embodiment of the light-shielding flange.

FIG. 2B is a cross section of the light-shielding flange in FIG. 2A.

### DETAILED DESCRIPTION OF THE INVENTION

The present invention is now specifically explained.

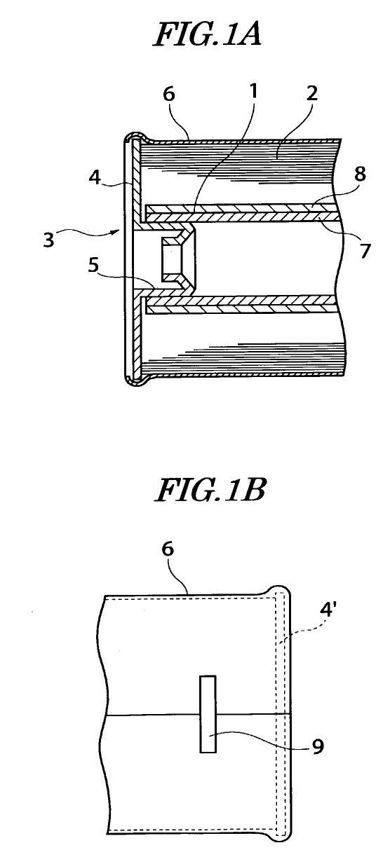

FIG. 1A is a partial cross section of one embodiment of the roll-form light-sensitive material light-shielding package of the present invention. Referring to FIG. 1A, a light-shielding spool 1 comprises a hollow paper spool 7 and a cushion layer 8 provided on the outer peripheral surface of the spool 7. A long length of light-sensitive material 2 is wound around the outer periphery of the light-shielding spool 1 in a roll state. A light-shielding flange 3 has on its central part a cylindrical insertion part 5, which is made of a hard resin, and surrounding it a flange part 4, which abuts against the roll surface formed from the edge of the light-sensitive material. The insertion part 5 of the light-shielding flange 3 is inserted into the hollow part of the spool 1 from opposite sides. The long length of light-sensitive material 2 has a light-shielding leader 6 on the outermost peripheral leading edge. This light-shielding leader 6 is preferably wider than the long length of light-sensitive material 2 and covers the outer periphery of the light-sensitive material 2 so as to shield it from light, the length of the light-shielding leader 6 being at least 1.5 times the perimeter of the roll of the long length of light-sensitive material 2.

The outer surface of the roll-form light-sensitive material light-shielding package is shown in FIG. 1B, in which the free end of the light-shielding leader 6 covering the light-sensitive material is retained by means of a tape 9.

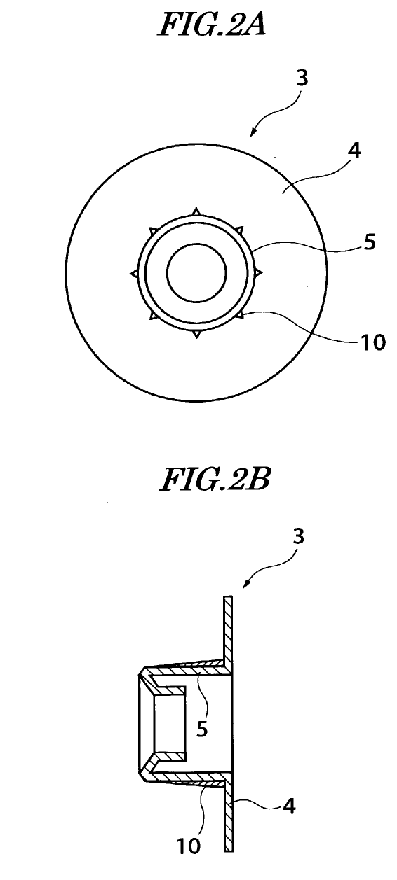

FIG. 2 is a conceptual illustration showing one embodiment of the light-shielding flange 3. FIG. 2A is a front view showing an example of projections 10 provided on the outer periphery of the cylindrical insertion part 5. As shown in FIG. 2B, the projections 10 are formed on the outer periphery of the insertion part so as to be tapered in the direction in which the insertion part is inserted.

Members constituting the light-sensitive material light-shielding package of the present invention are explained below in sequence.

With regard to the hollow light-shielding spool, it is necessary for at least the two ends thereof to be hollow so that the insertion parts of the flanges can be accommodated therein, but it is preferably hollow along the whole length.

The material of the light-shielding spool is preferably paperboard and is preferably formed by laminating a paperboard such as a kraft pulp paper or an alkaline pulp paper. The quality of the paper materials is not particularly limited, but it is preferable to use a paper that has a low content of free sulfur, etc. and does not affect the photographic properties of the light-sensitive material. The spool used in the present invention can usually be formed by laminating in a spiral form on the order of 5 to 15 layers of paperboard to give a thickness of about 2.0 mm to 3.0 mm, and cutting it to a required length. The spool so laminated usually has the required light-shielding properties, but in order to enhance the light-shielding properties a light-shielding material can be added to the paperboard as appropriate.

The cushion layer can be provided by wrapping a material having an appropriate resilient compressibility (cushion properties) around the outer peripheral surface of the light-shielding spool at a required thickness. When winding a light-sensitive material around the spool wrapped with a sheet having cushion properties, the cushion layer is compressed by the wind-up tension, thus decreasing the thickness of the cushion layer. Since the thickness of the cushion layer is often reduced by about a half by winding the light-sensitive material around it, it is preferable for the cushion layer to have a thickness of about 0.1 to 3.0 mm in the free state, and more preferably 0.2 to 2.0 mm.

As hereinbefore described, the present inventors have achieved the object by providing a cushion layer on the outer peripheral surface of the spool. When a light-sensitive material is wound around the spool, the cushion layer is compressed by the winding up and the layer thickness is reduced. However, by setting the thickness of the cushion layer in a compressed state so that it is greater than an increase in the body size of the spool that has been expanded by the insertion part of the light-shielding flange, the expansion of the spool can be absorbed.

With regard to the material used for providing the cushion layer, there are film sheets of a foamed resin such as a polyethylene foam, a polypropylene foam, or a polystyrene foam, foamed pulp sheets, nonwoven cloth, etc. It is preferable to use as the cushion layer a synthetic resin foam having a foam expansion ratio of 10 to 50 times.

Examples of the foamed resin film include ‘Miramat’ (registered trademark, manufactured by JSP Corporation) and ‘Toraypef’ (registered trademark, manufactured by Toray Industries, Inc.).

Miramat is a polyethylene obtained by a high pressure method with a foam expansion ratio of 25 to 30 times and has the same degree of moisture resistance and water resistance as that of polyethylene. It therefore has the merit of preventing moisture absorption from the spool side. Furthermore, Miramat is available as a product having thicknesses from 0.5 mm to 10 mm and can therefore be chosen as appropriate for use in the present invention.

There are grades of Toraypef produced from polypropylene or an ethylene-vinyl acetate copolymer in addition to those produced from polyethylene. Since its foam expansion ratio ranges from 5 times to 40 times, it can be chosen as appropriate. Since it has the same degree of moisture resistance and water resistance as that of an unfoamed sheet, moisture absorption from the spool can be prevented.

With regard to the foamed pulp sheet, there is Fuwattolite (registered trademark, manufactured by Oji Paper Co., Ltd.). The density of Fuwattolite is about 0.20 g/cm³, which is about ⅕ of that of normal high quality paper and white paperboard.

As in Miramat and Toraypef, when foam cells are isolated in a film, the same degree of moisture resistance and water resistance as that of an unfoamed resin film can be obtained, and these materials are preferable as the cushion material used in the present invention.

The light-shielding flange comprises a disc-shaped flange part and a cylindrical insertion part provided in the center thereof. Inserting the cylindrical insertion part into the hollow part inside the light-shielding spool shields the long length of roll-form light-sensitive material effectively from light entering from its side faces.

Furthermore, the cylindrical insertion part has in its central part an aperture through which a metal spindle can pass so that it can be loaded in exposure equipment such as a platemaking scanner. The spindle is inserted into the inside of the cylindrical insertion part within a laser scanner, etc., thereby supporting the light-sensitive material at a predetermined position.

The external diameter of the cylindrical insertion part is slightly larger than the internal diameter of the light-shielding spool into which it is inserted, thereby producing a mating force between the light-shielding flange and the light-shielding spool. The relationship between the external diameter of the cylindrical insertion part and the internal diameter of the light-shielding spool is preferably set so that the mating force is produced in the range of 30 kgf to 60 kgf. When the mating force is 20 kgf or less, there is the possibility that the light-shielding flange might be displaced or fall out due to vibration or dropping of the light-sensitive material package during transport. When the mating force exceeds 70 kgf, the light-shielding spool expands greatly, and there is the possibility that the cushion layer might not be able to absorb the expansion of the light-shielding spool.

ISO 14535 describes two types of flanges, that is, a rigid flange and a flexible flange.

The rigid flange is used when the spindle of the exposure equipment is inserted therein. The light-sensitive material light-shielding package of the present invention employs a rigid light-shielding flange. This rigid light-shielding flange can be made by molding an abrasion resistant polystyrene resin, a high impact polystyrene resin, various types of polypropylene resin, an ABS (acrylonitrile/butadiene/styrene copolymer) resin, etc. In order to obtain the required light-shielding properties, the resin is kneaded with a light-shielding material such as carbon black before molding. The thickness of the light-shielding flange is preferably 1 mm to 5 mm. In accordance with the ISO 14535 standard, the thickness of the rim of the flange is defined as 3 mm±0.3 mm.

In order to increase the mating force with the spool, it is preferable to provide a projection, that is, a rib, on the outer periphery of the cylindrical insertion part of the light-shielding flange.

As the light-shielding flange, it is possible to use a light-shielding flange having no projections on its cylindrical insertion part as shown in FIG. 1A, but it is preferable to use a flange having projections on its cylindrical insertion part as shown in FIG. 2A because no displacement is caused in winding. It is preferable for the projections to be formed so that they taper toward the forward end of the cylindrical insertion part from the base of the cylindrical insertion part close to the disc-shaped end since the spool can be inserted easily. Moreover, the flange can be pulled out easily after the light-sensitive material is used. The number of the projections is not particularly limited, but it is preferable to provide 4 to 8 projections on the outer periphery of the insertion part at equal intervals.

As a most preferred mode, it is preferable to set the cylindrical insertion part so that a mating force on the order of 5 kgf to 20 kgf is obtained without projections, and to achieve a final mating force of 30 kgf to 60 kgf by providing projections thereon.

The light-shielding leader employs a thermoplastic resin film such as a polyethylene film or an OPP (oriented polypropylene) film.

The light-shielding leader can employ a composite film in which a plurality of thermoplastic resin films are laminated. A heat-shrinkable film can also be used.

The light-shielding properties of the light-shielding leader can be obtained by adding a light-shielding material such as carbon black thereto.

The light-shielding leader is formed as described in JP-A-6-175291 (JP-A denotes a Japanese unexamined patent application publication), JP-A-8-62783, and JU-B-6-31465. That is, it is preferable for the light-shielding leader to extend beyond the flange part (disc-shaped end) of the light-shielding flange so as to cover a part of the outer side face in order to shield it from light. The light-shielding leader described in the publications above can be pulled so as to cover the outer peripheral surface of the light-sensitive material, and by making both edges of the light-shielding leader shrink the disc-shaped end of the light-shielding flange can be fixed. Furthermore, the light-shielding leader described in JP-A-2001-183777 can be shrunk in the vicinity of the disc-shaped end of the light-shielding flange by applying heat to the light-shielding leader while covering the outer peripheral surface of the light-sensitive material therewith.

The roll-form light-sensitive material light-shielding package of the present invention can be produced by winding the long length of light-sensitive material around the light-shielding spool formed by providing the cushion layer on the outer peripheral surface of the spool made of paperboard, etc., then inserting the light-shielding flanges having the cylindrical insertion part made of a hard resin into opposite sides of the spool, joining the light-shielding leader having a width greater than that of the light-sensitive material to the leading edge of the long length of light-sensitive material, and then covering the light-sensitive material over at least 1.5 times the outer perimeter.

When the roll-form light-sensitive material light-shielding package of the present invention is used, the light-shielding leader connected to the light-sensitive material is removed, and unexposed light-sensitive material can then be cut into a required size and used. Furthermore, the package can be loaded in exposure equipment in an illuminated room, and recording can be carried out automatically while cutting the material into sheet form within the equipment. Moreover, it is also possible to wrap it around a recording drum automatically within the exposure equipment and carry out recording.

With regard to the light-sensitive material of the roll-form light-sensitive material light-shielding package of the present invention, light-sensitive materials such as color paper, color negative film, heat-developable X-ray film, and computer phototypesetting paper can be used. In the case where a support of the light-sensitive material is paper, the support easily deforms, and application of the present invention thereto shows an outstanding effect.

In the roll-form light-sensitive material light-shielding package of the present invention, the light-shielding flanges are not displaced from the light-shielding spool by vibration, dropping, etc. during transport. Even when the package is stored at high temperature for a long period of time, the side edges of the long length of light-sensitive material do not elongate nonuniformly, and when the light-sensitive material is wrapped around a recording drum and an image is recorded, the image on opposite sides of the light-sensitive material are not blurred.

### EXAMPLES

The present invention is explained more specifically below by means of examples, but the present invention is not limited thereby.

### Example 1

A 0.5 mm thick kraft pulp paper (KP paper, manufactured by Koyo Paper Mfg. Co., Ltd.) was wound twice, and a 0.5 mm thick alkaline pulp paper (NSA paper, manufactured by Oji Paper Co., Ltd.) was further wound around twice to give a paper spool having a thickness of about 2 mm, and one of the three types of cushion materials shown in Table 1 was further wrapped around the paper spool so as to give a thickness of 1 mm, thus preparing light-shielding spools A, B, and C. These spools were formed by continuously winding the papers and the cushion material in a spiral manner so as to have an internal diameter of 71.15 mm, and cutting it to a length of 635 mm.

Next, a light-shielding flange was prepared so as to conform to the ISO 14535 standard using a polystyrene resin kneaded with carbon black. The dimensions of the light-shielding flange were such that the external diameter of the flange part was 130.80 mm, the external diameter of the cylindrical insertion part was 71.30 mm, the internal diameter of the aperture provided in the center of the cylindrical insertion part was 37.40 mm, and the thickness of the rim of the flange part was 3.00 mm. Six projections were further provided as shown in FIG. 2 on the base of the cylindrical insertion part at equal intervals. Since the maximum height of the projections was set at 0.35 mm, the maximum diameter of the cylindrical insertion part was 72.00 mm.

59 m of ‘Speed Proof Paper’ color paper cut to a width of 635 mm was wound around each of the above light-shielding spools A, B, and C, and the above light-shielding flanges were then inserted into the hollow part of each of the light-shielding spools from either end.

Next, a light-shielding leader was connected to the outermost end of the long length of roll-form light-sensitive material wound around each of the light-shielding spools so as to cover the outer peripheral surface of the light-sensitive material. Finally, the free end of the light-shielding leader was retained by a tape to give roll-form light-sensitive material light-shielding packages A, B, and C.

The light-shielding leader was a 0.14 mm thick polyethylene resin film containing carbon black, the width of the part thereof covering the light-sensitive material was 65.7 cm, and the length of the covering part was about 1.5 times the outer perimeter of the light-sensitive material.

For the roll-form light-sensitive material light-shielding packages A, B, and C thus produced, the amount of deformation in the body size at either end of the light-shielding spool due to insertion of the insertion part was (72.00−71.15)/2=0.425 (mm).

The mating force between the light-shielding flange and the light-shielding spools was 45 kgf.

The cushion layer of each of the light-shielding spools was made so as to have a thickness of 1 mm, but when the roll-form light-sensitive material light-shielding packages were made the cushion layer was compressed to a thickness of about 0.5 mm. However, since the amount of deformation at either end of each of the light-shielding spools was 0.425 mm, the increase (expanded radius) in the body size of each of the light-shielding spools was smaller than the thickness of the cushion layer, and expansion of the body size of the light-shielding spools could thereby be absorbed.

Evaluation of the performance was carried out for the roll-form light-sensitive material light-shielding packages A, B, and C produced above, a conventional type D having no cushion layer, and a comparative sample E to which, instead of the cushion layer, a 1 mm layer was added by winding kraft pulp paper twice. The results are given in Table 1. It is clear that the present invention is superior.

Drop Test of Package

A test was carried out according to JIS Z0200 level III. More specifically, the packages produced above were placed in external corrugated cardboard boxes and dropped from a height of 35 cm.

Subsequently, the packages were opened and examined to see whether or not the light-shielding flanges had been displaced.

They were evaluated using ‘+’ for the case where no displacement was observed, and ‘−’ for the case where even the slightest degree of displacement was observed.

Sharpness of Image on Sides of Light-sensitive Material

In order to simulate a state in which the product was stored in a warehouse, the packages were allowed to stand at 46° C. and 30% RH for one day. The packages were then opened, the light-sensitive materials were loaded in a Luxel Speedproof 8000 drum system exposure instrument (manufactured by Fuji Photo Film Co., Ltd.) and exposed to light by means of a CMYK 75% screen tint at a size of 635 mm×920 mm. The materials were taken out and developed, and examined to see whether or not the screen tint had been uniformly exposed.

They were evaluated as ‘+’ for the case where exposure was uniform and the image was sharp and ‘−’ for the case where the sides of the film were blurred.

TABLE 1

| | | Drop | Image |
|---|---|---|---|
| Package | Cushion layer | test | sharpness |
| A (Invention) | Miramat (manufactured by JSP | + | + |
| | Corporation), 1 mm; foam expansion | | |
| | ratio 30 times, polyethylene | | |
| B (Invention) | Toraypef (manufactured by Toray | + | + |
| | Industries, Inc.), 1 mm; foam | | |
| | expansion ratio 15 times, polypro- | | |
| | pylene | | |
| C (Invention) | Fuwattolite (manufactured by Oji | + | + |
| | Paper Co., Ltd), 1 mm; foam | | |
| | expansion ratio 10 times, paper | | |
| D | None | + | − |
| (Comparative) | | | |
| E | KP paper (manufactured by Koyo | + | − |
| (Comparative) | Paper Mfg. Co., Ltd.), 1 mm; | | |
| | kraft pulp paper | | |

For reference, samples were prepared by increasing the number of windings of alkaline pulp paper of the light-shielding spool in Comparative Example E from two to four so as to make a total thickness of 4.0 mm and from two to six so as to make a total thickness of 5.0 mm, and when the effect was tested in the same manner as above, the same effect as that exhibited by the cushion layer was obtained. However, there were the problems that the thickness of the light-shielding spool increased compared with the case of the cushion layer and that the cost increased.

What is claimed is:

1. A roll-form light-sensitive material light-shielding package comprising:
a hollow light-shielding spool;
a long length of roll-form light-sensitive material wound around the outer periphery of the spool;
a light-shielding flange having an insertion part that is fitted into a hollow part of the spool, and a flange part that abuts against a roll surface of the light-sensitive material;
a light-shielding leader joined to the leading edge of the long length of light-sensitive material and covering the outer periphery of the light-sensitive material; and
a cushion layer on the surface of the spool;
wherein the cushion layer has a thickness that can absorb expansion of the spool caused by insertion of the insertion part of the flange into the spool.

2. The roll-form light-sensitive material light-shielding package according to claim 1 wherein the insertion part of the flange is a cylindrical insertion part, and a plurality of projections are formed around the outer periphery of the insertion part, the projections being tapered in the direction in which the insertion part is inserted.

3. The roll-form light-sensitive material light-shielding package according to claim 1 wherein the cushion layer employs a foamed synthetic resin having a foam expansion ratio of 10 to 50 times.

4. The roll-form light-sensitive material light-shielding package according to claim 1 wherein the light-shielding spool is hollow over its whole length.

5. The roll-form light-sensitive material light-shielding package according to claim 1 wherein the light-shielding spool is made of paperboard.

6. The roll-form light-sensitive material light-shielding package according to claim 1 wherein the light-shielding spool is formed by laminating a kraft pulp paper and an alkaline pulp paper.

7. The roll-form light-sensitive material light-shielding package according to claim 1 wherein the light-shielding spool is formed by laminating 5 to 15 layers of paperboard in a spiral form to give a thickness of 2.0 mm to 3.0 mm, and then cutting to a width that is the same as that of the roll-form light-sensitive material.

8. The roll-form light-sensitive material light-shielding package according to claim 1 wherein the thickness of the cushion layer that has been compressed by winding the roll-form light-sensitive material is greater than an increase in the body size of the spool that has been expanded by insertion of the light-shielding flange.

9. The roll-form light-sensitive material light-shielding package according to claim 1 wherein the cushion layer has a thickness of 0.1 to 3.0 mm in the free state.

10. The roll-form light-sensitive material light-shielding package according to claim 1 wherein the cushion layer is made of a foamed resin film sheet, a foamed pulp sheet, or a nonwoven cloth.

11. The roll-form light-sensitive material light-shielding package according to claim 2 wherein the mating force between the spool and the cylindrical insertion part is 30 kgf to 60 kgf.

12. The roll-form light-sensitive material light-shielding package according to claim 1 wherein the light-shielding flange is made of a polystyrene resin, a high impact polystyrene resin, a polypropylene resin, or an ABS resin.

13. The roll-form light-sensitive material light-shielding package according to claim 1 wherein the light-shielding flange has a thickness of 1 mm to 5 mm.

14. The roll-form light-sensitive material light-shielding package according to claim 2 wherein the cylindrical insertion part is provided with 4 to 8 projections at equal intervals on its outer periphery.

15. The roll-form light-sensitive material light-shielding package according to claim 14 wherein the mating force between the spool and the cylindrical insertion part provided with the projections is 30 kgf to 60 kgf.

16. The roll-form light-sensitive material light-shielding package according to claim 1 wherein the light-shielding leader comprises a thermoplastic resin film.

17. The roll-form light-sensitive material light-shielding package according to claim 1 wherein the light-shielding leader has a width that is larger than that of the roll-form light-sensitive material, and a length that is at least 1.5 times the roll perimeter of the long length of light-sensitive material.

18. The roll-form light-sensitive material light-shielding package according to claim 1 wherein the light-shielding leader covers the roll-form light-sensitive material by extending beyond the flange part of the light-shielding flange so as to cover a part of the outer side face of the light-shielding flange.

19. The roll-form light-sensitive material light-shielding package according to claim 1 wherein the light-sensitive material of the roll-form light-sensitive material light-shielding package is a color paper, a color negative film, a heat-developable X-ray film, or a computer phototypesetting paper.
